(19) United States
(12) Patent Application Publication
(10) Pub. No.: US 2026/0162126 A1
(43) Pub. Date: Jun. 11, 2026

(54) Systems and Methods for Detection of Scam in a Smart Device App by Comparing Versions of the App

(71) Applicants: Birendra Jha, Pasadena, CA (US); Ashwini Rao, Pasadena, CA (US)

(72) Inventors: Birendra Jha, Pasadena, CA (US); Ashwini Rao, Pasadena, CA (US)

(73) Assignee: Eydle Inc., Pasadena, CA (US)

(21) Appl. No.: 19/397,566

(22) Filed: Nov. 21, 2025

Related U.S. Application Data
(60) Provisional application No. 63/728,161, filed on Dec. 5, 2024.

(51) Int. Cl. G06Q 30/018; G06F 21/57

(52) U.S. Cl. CPC G06Q 30/018; G06F 21/57

(57) ABSTRACT

Existing scam-app detection systems often miss apps that shift over time from benign to malicious because they analyze each version independently and rely on incomplete brand databases. The disclosed systems overcome these limitations by comparing images, text, and other app elements across multiple versions of the same app. This cross-version analysis exposes suspicious changes that existing systems fail to detect. Because the new approach does not depend on a brand database, it avoids the high computational cost of comparing every app version to every known brand and the persistent problem of incomplete brand lists. In one embodiment, the system receives app-element data from different app versions, applies pattern-recognition and/or object-detection techniques to compare these inputs, and computes a scam-score based on their similarities or changes. The resulting score, optionally accompanied by recommended actions, is then presented to the user to support timely detection of evolving scam apps.

### CROSS REFERENCE TO RELATED APPLICATIONS

The present application claims priority to and the benefit of U.S. Provisional Patent Application Ser. No. 63/728,161 filed on Dec. 5, 2024, titled “Systems and Methods for Detection of Scams in a Mobile Phone App by Comparing Versions of the Mobile Phone App.” This reference is incorporated in its entirety.

### FIELD OF INVENTION

The present disclosure relates generally to the detection of social engineering scams committed using smart device apps and, more particularly, provides systems and methods for detecting whether a smart device app is a scam or not based on comparisons between versions of an app.

### BACKGROUND

Scams conducted using apps (application software) running on mobile devices and smart devices have been growing in number. Here, mobile and smart devices include communication devices (such as smartphones), entertainment devices (such as smart TVs), appliances (such as refrigerators and laundry washer systems), transportation devices (such as automobiles and electric scooters), health monitoring devices (such as smartwatches, Oura Smart Ring, and FitBit), security devices (such as camera), and Internet-of-Things (IoT) devices that contain one or more processors and a memory storing instructions that are executed by the processors to cause the system to perform operations. The scams target smart device users who download, install, and execute these apps on a smart device. The scam apps trick the user into giving the user's sensitive personal and/or financial information to the developers of the scam app, who then use the information to carry out the scam against the user. The scams generally cause monetary loss, identity theft, and/or reputational loss. However, other types of scams are also possible, for example, showing excessive ads, installing malware on the user's device, and signing up the user for predatory financial loans with high interest rates. The scam apps often trick the users by impersonating a well-known legitimate business or brand, for example, a bank or an online shopping store. The impersonation can happen in one or many elements of the app, e.g., in the app's title, icon, or other app-related images such as splashscreens. In a commonly used impersonation scam tactic, the app's icon looks like a modified copy of the logo of the brand being impersonated. Other types of impersonation are also possible. For example, in mass-brand impersonation, a group of brands belonging to a certain category, for example, online shopping or banking, are simultaneously impersonated using one single image that copies parts of different brand logos.

Smart device apps are often downloaded from an app store or other software vendors.

Below, store refers to any business, person, or group providing apps. These stores collect and provide apps and app-related data, such as user reviews and ratings. The stores also incur financial and/or reputation losses due to scam apps. To address this issue, a store may implement systems and methods to detect and remove scam apps uploaded to their store. A common method for detecting scam apps is to detect the presence of a logo (or logos) of a brand (or multiple brands) inside the app's icon image displayed on the store's website. The legitimate brands are defined in a monitored or protected brand database that is used by the scam app detection system to monitor the apps for scams. After a scam is detected in an app's software version, the app review system, which usually follows the scam detection system, may take an action on the app. Actions include removal of the app from Store and asking the app developer to upload a new version of the app after rectifying the scam issue, e.g., by removing any occurrence of brand impersonation in the app. When the new app version is uploaded to Store, the scam detection system checks the new version against the monitored brand database to detect the occurrence of scams in that version.

The scammers change their scam or fraud tactics to evade detection and persist longer on the store to accrue more downloads and increase their review ratings, often leading to bigger scam losses and many scam victims. One of the evasion tactics used by scammers is to change the elements of the app, for example, the app icon and splashscreens, between two versions of the app, in a way that defeats the scam detection system. We define this as a version scam. Existing scam detection systems fail to detect version scams because they check the elements of a given version of an app for impersonation of brands prescribed in a monitored brand database that remains incomplete due to an ever-changing list of legitimate brands, without comparing different app versions.

In one type of the version scam, the old version of an app does not commit a scam, and the new version commits a scam by impersonating a brand that is not included in the monitored brand database of an existing scam detection system. The existing system fails to detect the scam in the new version because the brand is not in the monitored or protected brand database. A new type of detection system can be designed and implemented to compare the two versions of the app to detect this type of version scam based on the similarity between the two versions of the app. Since the old version did not commit a scam and the new version commits a scam, the new version must have dissimilarities compared to the old version. The systems and methods for designing and implementing such a scam detection system is presented in the invention disclosed here.

In one type of the version scam, the old app version commits a scam, the app review system asks the app developer to rectify the issue, the developer uploads a new app version with insufficient or unsatisfactory changes that do not rectify the issue, and an existing detection system may be able to detect the scam in the new version, if the app's target of impersonation is included in the monitored brand database of the detection system. The new detection system disclosed here can detect this type of version scam because a comparison of the two app versions will reveal the insufficiency of the changes in the new version. Moreover, the new detection system disclosed here will be computationally more efficient and faster because comparing two versions is faster than detecting the occurrence of impersonation by comparing the app's elements against hundreds of brands that are usually present in a monitored brand database.

### SUMMARY OF THE INVENTION

The systems and methods described in this invention can detect apps committing scams that are difficult or impossible to detect using existing detection systems and prior art of scam detection.

In one embodiment, a system for scam detection is disclosed, the system comprising: one or more processors; and a memory storing instructions that, when executed by the one or more processors, cause the system to perform operations comprising: comparing two versions of an app to detect changes between the versions based on patterns in the elements of the app; calculating a scam score based on the comparison; and presenting the score to the user. This system has been named the version pair comparison system.

In one embodiment, a system for comparing multiple versions of an app to detect changes among the versions is provided. This has been named the multi-version comparison system.

In one embodiment, a system for comparing two versions of an app to detect changes in the app's elements, one element considered at a time, is provided. This has been named the version-pair element-wise comparison system.

In one embodiment, a system for comparing two versions of an app to detect changes in the app's elements, multiple elements considered at once, is provided. This has been named the version-pair element-cloud comparison system.

In one embodiment, a system for comparing multiple versions of an app to detect changes in the app's elements, one element considered at a time, is provided. This has been named the version-cloud element-wise comparison system.

In one embodiment, a system for comparing multiple versions of an app to detect changes in the app's elements, multiple elements considered at once, is provided. This has been named the version-cloud element-set comparison system.

### BRIEF DESCRIPTION OF THE DRAWINGS

The features, nature, and advantages of the present disclosure will become more apparent from the detailed description set forth below when taken in conjunction with the drawings, in which:

FIG. 1 illustrates an exemplary flow diagram of a scam app detection system based on a version-pair comparison of app versions;

FIG. 2 illustrates an exemplary flow diagram of a scam app detection system based on a multi-version comparison of app versions;

FIG. 3 illustrates an exemplary flow diagram of a scam app detection system based on a version-pair element-wise comparison of app versions;

FIG. 4 illustrates an exemplary flow diagram of a scam app detection system based on a version-pair element-cloud comparison of app versions;

FIG. 5 illustrates an exemplary flow diagram of a scam app detection system based on a version-cloud element-wise comparison of app versions;

FIG. 6 illustrates an exemplary flow diagram of a scam app detection system based on a version-cloud element-set comparison of app versions.

### DESCRIPTION

An app store is an online store containing apps (application software) that are available for download and subsequent installation on a computing device with one or more processors and memory storing instructions. The app store is operated by a person, persons, or a company named below as Store. Google Play Store, Apple App Store, Samsung Galaxy Store, LG Content Store are examples. Other stores exist. An app is uploaded to the Store by the app developer, named here as Developer. A developer can be a person or persons, e.g., a company. The user of the device downloads, installs, and executes apps on the device. An app executing on a device is software that can perform a wide variety of functions, e.g., the app can display images, texts, and/or videos on the device, with or without audio; the app can ask for and collect data from the user; the app can open a website with or without user's input; the app can display online advertisements; the app can establish communication among different users on different computing devices; and the app can install software on the device's memory with or without user's consent. Common purposes of apps comprise advertising and selling products and services, online gaming, entertainment, communication, information collection and generation, and information sharing.

Developer creates and maintains a developer account on Store, which allows Developer to provide information about Developer and the app to Store. The developer-provided information includes the following: developer's name, app name or title, app icon, app category, app description, screenshot images of the running app (named here as splashscreens), and the app installation file. Some of this information is used by Store to create elements associated with the app that are displayed to a user on the user's device, with the element list comprising:
1. App icon. This is image data.
2. App title. This is text data.
3. App developer name and contact information (e.g., email address). This is text data.
4. App splashscreens. This is either one image or a set of images.
5. Screenshots of the running app on a smart device, in an emulator software, or in a cloud computing environment. This is either one image or a set of images.
6. App category. This is text data. This is selected by Developer from a list of categories defined by Store. Example categories are Gaming, Shopping, Financial, and Government.
7. App description. This is text data.
8. App permissions. This is text data.
9. Store may create and display additional elements of an app. Such elements include the number of times users have downloaded the app, the number and content of app reviews, and the app rating. App Reviews are based on the text submitted by other users who installed and interacted with the app in the past. An app rating is usually a positive numeric value, for example, rating can be a real number between 1.0 and 5.0. Store can calculate such app ratings based on the ratings submitted by users to Store.
10. Other elements, similar or different to the elements listed above, can be used for comparing app versions and are included by detection systems presented in this disclosure.

App element data can be available in file formats comprising image formats (JPG, JPEG, PNG, PDF, SVG, TIF), text formats (TXT, CSV, DOC), and video formats (AVI, MP4, MPEG).

Elements of an app, defined in [0023], can change over time. The additional elements can be different between the two versions of an app. Such elements may or may not be cumulative over time, may or may not be version-specific, and may or may not be informative in detecting version scams. For example, some app reviews can get deleted over time, and the app rating can be version specific. The use of such additional elements in version scam detection is optional in this disclosure.

Over time, Developer can upload multiple versions of the app to Store. As a new version of an app become available, Store makes it available for download. Therefore, an App A can have multiple versions in Store's app database. We denote each version with a positive integer such that n versions of A can be expressed as a sequence of integers,

$$1 , 2 , 3 , … , n - 2 , n - 1 , n$$

where each integer denotes a version. Two arbitrary and different versions can be denoted by i and j, where

$$1 \leq i \leq n , 1 \leq j \leq n , i \neq j$$

The common reasons for Developer releasing a new version of the app include fixing software bugs in previous versions and expanding or improving the app's functionality, e.g., to improve the app's rating and/or to increase the number of downloads of the app. Although differences are expected between the new version and the previous version, the core features of the app are expected to remain unchanged or similar. Core features may include the logo and name of the brand used by the app. For example, the app of a legitimate bank is expected to show the bank's logo and name in the following elements: app's title, icon, splashscreens, and/or the running app screenshots regardless of the app version. See [0023] for a definition of app elements. Core features also include the app functionality and the app category. An app categorized by Developer as Shopping in a previous version is expected to remain under the Shopping category in the new version.

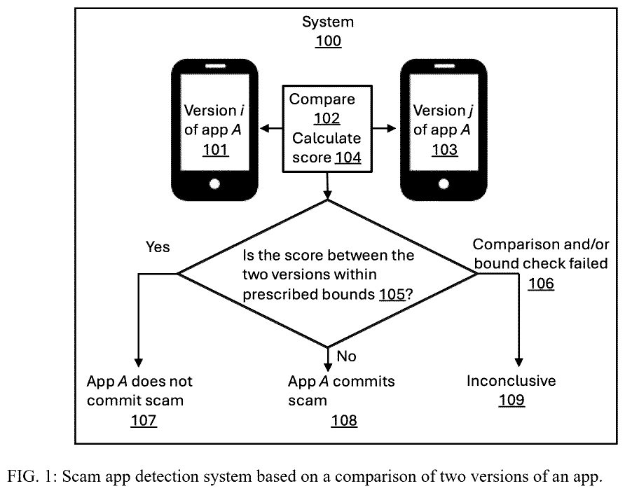

FIG. 1 illustrates a conceptual diagram of the scam app detection system 100. Two versions of App A, i and j, are compared by a comparison system 102 to determine whether A commits the scam. The comparison system 102 uses one or more app elements defined in [0023] where the element data type comprises text, image, video, or a combination of these and computes a score 104. Considering app icon as an example element, the app icon of version i 101 is compared with the app icon of version j 103 and if their difference expressed as a score 104 exceeds the bounds or thresholds 105, A is declared a scam app 107 or not a scam app 108. If the comparison or bound check fails 106, the result is inconclusive 109.

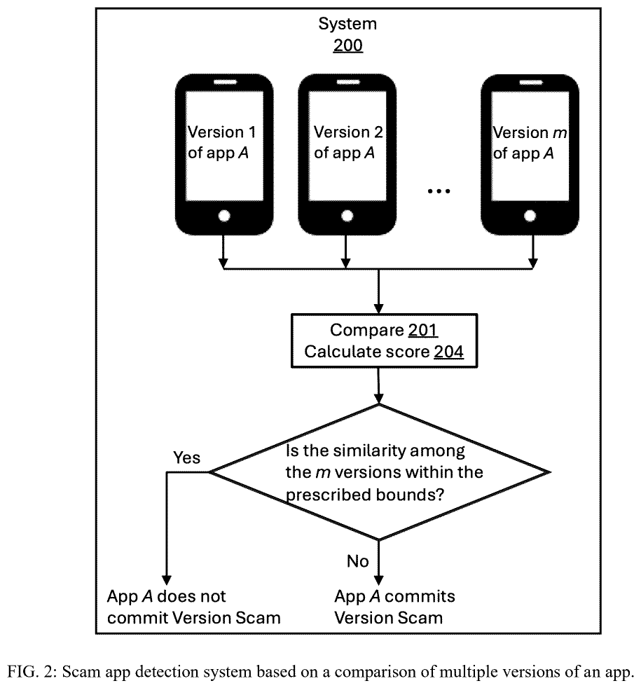

FIG. 2 illustrates a conceptual diagram of the scam app detection system 200, where m versions of the app, where 2≤m≤n, are compared by the comparison system 201 to detect the version scam. The comparison uses one or more elements of the m versions.

The similarity score 104 can be binary (e.g., 0 or 1, similar or dissimilar, scam or no scam), a real number (e.g., a similarity value of 0.4), a percentage (e.g., 40%), a label text (e.g., App A impersonates brand X), or a combination of these.

The comparison system parts 102, 201, 301, 302, 401, 402, 501, 502, 601, and 602 can be based on a deterministic algorithm, a probabilistic algorithm, or a combination of the two.

In an implementation of the invention, machine learning algorithms and/or artificial intelligence (AI) algorithms are used by system parts 102, 201, 301, 302, 401, 402, 501, 502, 601, and 602 to compare different versions of an app by pattern recognition, object detection, or classification and detect changes in the app's elements across versions. The algorithm list comprises of the following: support vector machine, linear regression, decision tree, Bayes method, and k-nearest neighbor, random forest, k-means clustering, neural networks, evolutionary algorithms, and natural language processing. AI algorithms further comprise of autoencoders (including variational and contractive), transformers, generative models (including generative adversarial networks), diffusion models, and other models that encode an input image, text, or image-text pair into one or more embedding tensors 301, 401, 501, and 601. In an implementation of the system, Foundational models, which are AI models trained on large amounts of data of different types (for example, image and text), are adapted to serve as a base for building comparison systems.

In an implementation of the invention, the comparison system 102, 201, 302, 401, 501, or 601 may perform a pixel-by-pixel comparison of two or more images to calculate the scam score. An example is the pHash or perceptual hashing algorithm that applies the discrete cosine transform or a wavelet transform to convert an image of pixels into a hash code or a fingerprint. Codes of different images are compared to calculate the score.

In an implementation of the invention, system part 102, 201, 302, 401, 501, or 601 performs pattern recognition on the input images, where a pattern is made up of a group of pixels in an image that may show attributes including, but not limited to, shape, size, position, and color of objects in the image data or texts in the string data. List of objects comprise geometric shapes (straight lines, curves, circles, and polygons), digits, alphabet fonts, buildings, and human or animal faces or body parts. The system compares the patterns in the input images or texts from one or more versions of the app to calculate the score 104, 204, 303, 402, 502, or 602.

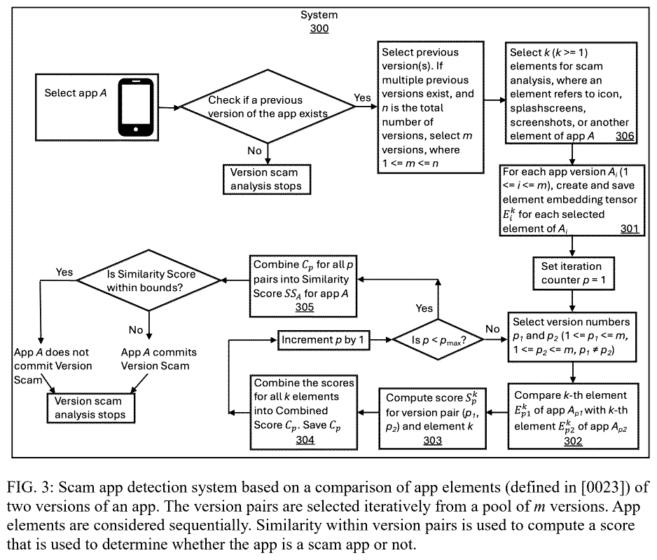

In an implementation of the invention, the score 303 is based on a pairwise similarity measure applied to the element embedding tensors of two versions i and j. FIG. 3 is an embodiment of the system. Examples of similarity measures include Cosine Similarity, Manhattan Similarity, and Euclidean distance. In an implementation of the Euclidean similarity, the score

$${S}_{p}^{k}$$

303 is based on the L2-norm of the vector of difference between the embedding vector of an element of version i and the embedding vector of the corresponding element of version j. As shown in FIG. 3, p is the iteration counter, and k is the element counter.

In an implementation of the invention, the score

$${S}_{p}^{k}$$

303 is based on a set similarity measure applied to the element embedding tensors 301 of versions i and j. Examples of such measures include the Overlap or Szymkiewicz-Simpson coefficient, Jaccard similarity coefficient also known as Tanimoto coefficient, and Sorensen-Dice coefficient.

In an implementation of the invention, the score Cₚ 304, 305, 403, 503, 504, or 603 is based on a combination of measures of similarity between an element of version i and the corresponding element of version j, where the combination includes all the elements selected by the detection system. Summation and multiplication are example mathematical operations for combining.

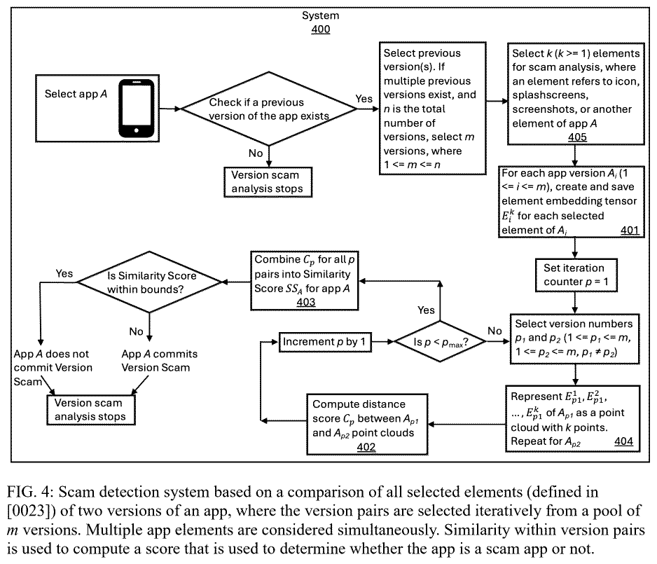

In an implementation of the invention, elements of a version are represented as a cloud of points 404, 505, or 604, with one point for each element. The point coordinates are defined in an embedding space 301, 401, 501, or 601, which is defined by the detection system. The embedding tensor of an image processed by an autoencoder is an example of a point. FIG. 4 is an embodiment of the system. The score Cₚ 402 is based on a measure of the distance between corresponding point pairs, with one point from version i's point cloud and the other point from version j's point cloud. Examples of distance measures include the Chamfer Distance (CD) and Earth Mover's Distance (EMD). The CD calculates the average of the squared distances from individual points of the version point cloud i to their corresponding minimum distance points of the version point cloud j and vice versa. EMD calculates the average pairwise distance between the version point cloud i and the version point cloudj, where the point pairs are determined in such a way as to minimize the total sum of pairwise distances while satisfying one-to-one point correspondences. Any measure of distance that can compute the distance between two point-clouds is included in this disclosure.

In an implementation of the invention, the score

$${S}_{p}^{k}$$

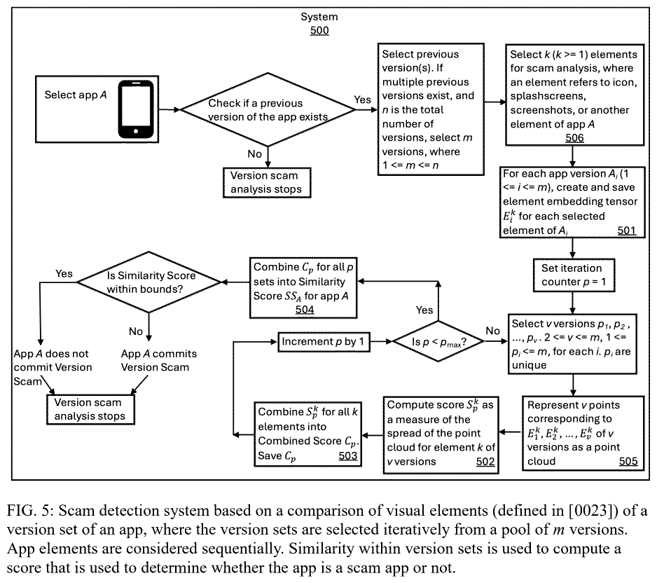

502 is based on attributes of a v-point cloud representing v versions of the app, where attributes comprise the size, standard deviation, or scatter of the point cloud. Each element can generate a point cloud of v points, where a point represents the embedding tensor of an element of version i in the point cloud. A combined score for all elements Cₚ 503 and 504 can be calculated by combining the individual scores corresponding to different elements. Summation and multiplication are example mathematical operations for combining scores. FIG. 5 is an embodiment of the system.

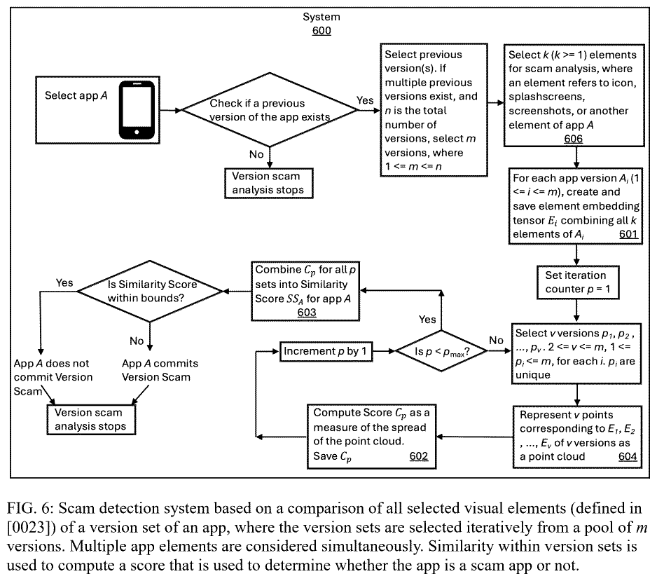

In an implementation of the invention, the score Cₚ 602 and 603 are based on attributes of a v-point cloud representing v versions of the app, where attributes comprise the size, standard deviation, or scatter of the point cloud, and k elements of a version are combined into one element. A point in the point cloud represents the embedding tensor of the combined element of version i. Appending along one of the dimensions of the embedding tensor is one example of combining multiple elements. FIG. 6 is an embodiment of the system.

In an implementation of the invention, multiple images in an element of a version 306, 405, 506, or 606 are combined/merged into one image or tensor before performing the version comparison in the system. An example is the set of splashscreens (defined in [0023]). In an implementation, the merging of splashscreens can be performed by appending the image pixel data of one splashscreen to the image pixel data of another splashscreen. Each image can be understood as a tensor with data stored in a tabular format with a given number of columns, number of rows, and number of color channels, e.g., Red, Green, and Blue channels. The images can be appended along the row, column, color, time, or another dimension of the image.

In some examples, all or a portion of example systems 100, 200, 300, 400, 500, and 600 may represent portions of a cloud-computing or network-based environment. Cloud-computing environments may provide various services and applications via the Internet. These cloud-based services (e.g., software as a service, platform as a service, infrastructure as a service, etc.) may be accessible through a web browser or other remote interface. Various functions described herein may be provided through a remote desktop environment or any other cloud-based computing environment.

In some examples, all or a portion of example systems 100, 200, 300, 400, 500, and 600 may represent portions of a smart device computing environment. Smart device computing environments may be implemented by a wide range of devices, including mobile phones, tablet computers, e-book readers, personal digital assistants, wearable computing devices (e.g., computing devices with a display, smartwatches, etc.), smart appliances (laundry washer, refrigerator, etc.), cars with user-installed apps, and the like. Various functions described herein may be provided for a smart device computing environment and/or may interact with a smart device computing environment.

The use of the word “a” or “an” when used in conjunction with the term “comprising” in the claims and/or the specification may mean “one,” but it is also consistent with the meaning of “one or more,” “at least one,” and “one or more than one.”

The use of the term “optionally” with respect to any element of a claim is intended to mean that the subject element is required, or alternatively, is not required. Both alternatives are intended to be within the scope of the claim. Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal configuration. “Such as” is not used in a restrictive sense, but for explanatory purposes.

Where methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

While the present disclosure emphasizes the embodiments, it should be understood that within the scope of the appended claims, the disclosure might be practiced other than as specifically described herein.

While the foregoing disclosure sets forth various embodiments using specific block diagrams, flowcharts, and examples, each block diagram component, flow chart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure. It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude other such embodiments, adaptations, variations, modifications or equivalent arrangements.

The scope of the present disclosure is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The description of the disclosure is provided to enable any person skilled in the art to make or use the disclosure. Various modifications to the disclosure will be readily apparent to those reasonably skilled in the art, and the generic principles defined herein may be applied to other variations without departing from the spirit or scope of the disclosure. Thus, the present disclosure is not intended to be limited to the examples and designs described herein but is to be accorded the widest scope consistent with the principles and novel features disclosed herein. Accordingly, the disclosure is not to be limited by the examples presented herein but is envisioned as encompassing the scope described in the appended claims and the full range of equivalents of the appended claims.

1. A system for detecting scam apps (application software executed on smart devices) by comparing versions of the app, the system comprising: one or more processors, and memory storing instructions that, when executed by the one or more processors, cause the system to perform operations comprising: receiving input data of types comprising: text, numeric, image, and video, wherein data relates to the app's elements comprising: app icon, app title, app developer name and contact information, app splashscreen images, screenshots of the app running on a computing device including virtual machines and emulator software, app category, app description, app permissions, and app-specific information provided by the app developer, app store, app store users, or a computing device; performing a comparison of app elements of different versions of the app; calculating a scam score value based on similarity between or among the app versions; and presenting the scam score with or without recommendations to the user.

2. The system of claim 1 wherein comparison methods perform pattern recognition, classification, and/or object detection in input data by methods comprising:
a. deterministic algorithms comprising pixel-by-pixel comparison of images; character-by-character or word-by-word comparison of text strings; pHash or perceptual hashing algorithm to transform the app element into a hash code and comparison of such codes; and support vector machine, linear regression, decision tree, or k-nearest neighbor algorithms to transform the app element and comparison of the transformed data;
b. probabilistic algorithms comprising random forest, k-means clustering, Bayes methods, neural networks, evolutionary algorithms, or natural language processing algorithms to transform the app element into an embedding tensor and comparison of the embedding tensors;
c. a combination of deterministic and probabilistic algorithms to transform the app element and comparison of the transformed data.

3. The system of claim 2 where a pattern is made up of a group of pixels in an image or a group of characters in a text string with attributes comprising shape, size, position, color, and meaning of objects or texts, wherein objects comprise geometric shapes (straight lines, curves, circles, and polygons), digits, alphabet fonts, human or animal body parts, natural scenery, and infrastructure scenery.

4. The system of claim 2 wherein the scam score value is based on:
a. a pairwise similarity measure, such as Cosine Similarity, Manhattan Similarity, and Euclidean distance, applied to the element tensors of two versions of an app;
b. the L2-norm of the vector of difference between the embedding tensor of an element of one app version and the embedding tensor of the corresponding element of another app version;
c. a set similarity measure, such as the Overlap or Szymkiewicz-Simpson coefficient, Jaccard similarity coefficient also known as Tanimoto coefficient, and Sorensen-Dice coefficient, applied to the element embedding tensors of app versions;
d. a combination of measures of similarity between an element of one app version and the corresponding element of another app version, where the combination includes all or a part of the elements.

5. The system of claim 2 wherein the elements of an app are represented as a cloud of points, with one point for each element, and the point coordinates are defined in an element embedding space that is defined by the system, wherein the score is based on a measure of the distance between corresponding point pairs, with one point in the pair coming from one app version's point cloud and the other point in the pair coming from another app version's point cloud, wherein distance measures comprising:
a. Chamfer Distance (CD) for calculating the average of the squared distances from individual points of one app version's point cloud to their corresponding minimum distance points of another app version's point cloud;
b. Earth Mover's Distance (EMD) for calculating the average pairwise distance between one app version's point cloud and another app version's point cloud, where the point pairs are determined to minimize the total sum of pairwise distances while satisfying one-to-one point correspondences;
c. measures that calculate the distance between two point-clouds.

6. The system of claim 2 wherein more than two versions of the app are compared, and the scam score is based on the attributes of a point cloud representing multiple versions of the app, where attributes comprise size, standard deviation, or scatter of the point cloud and the method comprises:
a. each element generating a point cloud of multiple points, where a point in the point cloud represents the embedding tensor of an element of an app version in the point cloud,
b. multiple elements of an app version combining into one or more elements, where combining operations comprise appending the element tensors along one of the dimensions of the tensor, and where a point in the point cloud represents the embedding tensor of the combined element of the app version;
c. one or more scores for all elements calculated by combining the individual scores corresponding to different elements, where combining operations comprise summation and multiplication of individual scores, weighted or otherwise.

7. The system of claim 2 wherein multiple images or text strings in an element of an app version are combined into one or more images, strings, or tensors before performing the version comparison, wherein combining operations comprise:
a. appending the pixel data of one image to the pixel data of another image along a dimension of the image, wherein dimensions comprise row, column, color, or time channels of an image tensor;
b. concatenating the textual data of one string to the textual data of another string.

8. The system of claim 2 wherein one or more versions of the app are known to be a scam app.

9. The system of claim 1 wherein multiple versions of multiple apps are used to obtain input data for app element comparison and scam score calculation.

10. The systems as illustrated and described.

11. The methods as illustrated and described.
